(19) United States
(12) Patent Application Publication
(10) Pub. No.: US 2021/0155792 A1
(43) Pub. Date: May 27, 2021

(54) SILANE-MODIFIED, SILICATE-CONTAINING INJECTION-MOULDED ITEMS

(71) Applicant: BASF SE, Ludwigshafen am Rhein (DE)

(72) Inventors: Maximilian LEHENMEIER, Ludwigshafen am Rhein (DE); Martin BUSSMANN, Ludwigshafen am Rhein (DE); Norbert EFFEN, Ludwigshafen am Rhein (DE); Johannes Klaus SPRAFKE, Ludwigshafen am Rhein (DE); Gabriel SKUPIN, Ludwigshafen am Rhein (DE)

(21) Appl. No.: 16/639,313

(22) PCT Filed: Aug. 9, 2018
(86) PCT No.: PCT/EP2018/071607

§ 371 Date: Feb. 14, 2020

(30) Foreign Application Priority Data
Aug. 15, 2017 (EP) 17186288.1

(51) Int. Cl. C08L 67/02; C08K 9/06; C08K 3/34; B29C 45/00

(52) U.S. Cl. CPC C08L 67/02; C08K 9/06; B29K 2067/00; B29C 45/0001; C08L 2201/06; C08K 3/346

(57) ABSTRACT

The present invention relates to an injection molded article comprising:
i) 30% to 90% by weight based on the total weight of the components i to iii of a biodegradable polyester comprising:
   i-a) 90 to 100 mol % based on the components a to b of succinic acid;
   i-b) 0 to 10 mol % based on the components a to b of one or more C₆-C₂₀ dicarboxylic acids;
   i-c) 99 to 100 mol % based on the components a to b of 1,3-propanediol or 1,4-butanediol;
   i-d) 0% to 1% by weight based on the components a to c of a chain extender and/or branching agent;
ii) 0% to 35% by weight based on the total weight of the components i to iii of polylactic acid;
iii) 10% to 35% by weight based on the total weight of the components i to iii of at least one methacryloylsilane- or vinylsilane-modified silicate selected from the group consisting of: kaolin, muscovite, montmorillonite, talc and wollastonite.

The present invention relates to an injection molded article comprising:
i) 30% to 90% by weight based on the total weight of the components i to iii of a biodegradable polyester comprising:
   i-a) 90 to 100 mol % based on the components a to b of succinic acid;
   i-b) 0 to 10 mol % based on the components a to b of one or more C₆-C₂₀ dicarboxylic acids;
   i-c) 99 to 100 mol % based on the components a to b of 1,3-propanediol or 1,4-butanediol;
   i-d) 0% to 1% by weight based on the components a to c of a chain extender and/or branching agent;
ii) 0% to 35% by weight based on the total weight of the components i to iii of polylactic acid;
iii) 10% to 35% by weight based on the total weight of the components i to iii of at least one methacryloylsilane- or vinylsilane-modified silicate selected from the group consisting of: kaolin, muscovite, montmorillonite, talc and wollastonite.

WO2015/169660 discloses non-surface-modified talc-containing injection molded articles. These injection molded articles are not completely satisfactory for high mechanical stress applications in terms of their notched impact strength and their elastic modulus.

It is accordingly an object of the present invention to provide injection molded articles which do not have the abovementioned disadvantages. It was a particular object of the present invention to produce an injection molded article having a high noteched impact strength and a high elastic modulus.

Surprisingly, this object was achieved by injection molded articles comprising:
i) 30% to 90% by weight, preferably 42% to 75% by weight, based on the total weight of the components i to iii of an aliphatic polyester i;
ii) 0% to 35% by weight, preferably 10% to 28% by weight, based on the total weight of the components i to iii of polylactic acid;
iii) 10% to 35% by weight, preferably 15% to 30% by weight, based on the total weight of the components i to iii of at least one methacryloylsilane- or vinylsilane-modified silicate selected from the group consisting of: kaolin, muscovite, montmorillonite, talc and wollastonite, preferably a wollastonite and especially preferably a kaolin.

The injection molded articles according to the invention exhibit a surprisingly high elastic modulus despite the low polylactic acid content or else despite the complete eschewal of polylactic acid and/or exhibit a good impact strength despite the polylactic acid content.

The invention is more particularly described hereinbelow.

The aliphatic polyesters i suitable for the invention are more particularly described in WO 2010/034711 which is hereby explicitly incorporated by reference.

Polyesters i generally have the following construction:
i-a) 90 to 100 mol % based on the components i-a to i-b of succinic acid;
i-b) 0 to 10 mol % based on the components i-a to i-b of one or more C₆-C₂₀ dicarboxylic acids;
ii-c) 99 to 100 mol % based on the components i-a to i-b of 1,3-propanediol or 1,4-butanediol;
i-d) 0% to 1% by weight based on the components i-a bis i-c of a chain extender or branching agent;

The polyesters i described are preferably synthesized in a direct polycondensation reaction of the individual components. The dicarboxylic acid derivatives are converted together with the diol in the presence of a transesterification catalyst directly into the polycondensate of high molecular weight. On the other hand the copolyester i may also be obtained by transesterification of polybutylene succinate (PBS) with C₆-C₂₀ dicarboxylic acids in the presence of diol. The catalysts used are typically zinc catalysts, aluminum catalysts and especially titanium catalysts. Titanium catalysts such as tetraisopropyl orthotitanate and especially tetraisobutoxytitanate (TBOT) have the advantage over the tin, antimony, cobalt and lead catalysts frequently used in the literature, for example tin dioctanoate, that residual amounts of the catalyst or conversion product of the catalyst remaining in the product are less toxic. This fact is particularly important in the case of the biodegradable polyesters, since they get directly into the environment, for example, in the form of composting bags or mulch films.

The succinic acid or a mixture of the dicarboxylic acids is generally initially heated to an internal temperature of 170° C. to 230° C. over a period of approximately 60-180 min generally in the presence of an excess of dial together with the catalyst and the resulting water is distilled off. The melt of the thus obtained prepolyester is then typically subjected to a condensation up to the desired viscosity with a viscosity number (VN) of 100 to 450 ml/g and preferably 120 to 250 ml/g at an internal temperature of 200 to 250° C. over 3 to 6 hours at reduced pressure with distillative removal of liberated diol.

The polyesters i according to the invention may moreover be produced by the processes described in JP 2008-45117 and EP-A 488 617. It has been proven advantageous to initially react components a to c to afford a prepolyester having a VN of 50 to 100 ml/g, preferably 60 to 80 ml/g, and then to react said prepolyester with a chain extender i-d, for example with diisocyanates or with epoxy-containing polymethacrylates, in a chain extension reaction to afford a polyester i having a VN of 100 to 450 ml/g, preferably 150 to 300 ml/g.

Employed as the acid component i-a are 90 to 100 mol %, based on the acid components a and b, preferably 91 to 99 mol % and especially preferably 92 to 98 mol %, of succinic acid. Succinic acid is obtainable by a petrochemical route as well as preferably from renewable raw materials as described, for example, in EPA 2185682. EPA 2185682 discloses a biotechnological method for producing succinic acid and 1,4-butanediol proceeding from different carbohydrates with microorganisms from the class of the Pasteurellaceae.

Acid component i-b is employed in 0 to 10 mol %, preferably 1 to 9 mol % and especially preferably 2 to 8 mol % based on the acid components i-a and i-b.

C₆-C₂₀ dicarboxylic acids b are to be understood as meaning in particular adipic acid, suberic acid, azelaic acid, sebacic acid, brassylic acid and/or arachidonic acid. Preference is given to suberic acid, azelaic acid, sebacic acid and/or brassylic acid. The above-mentioned acids are obtainable from renewable raw materials. For example, sebacic acid is obtainable from castor oil. Such polyesters feature excellent biodegradability characteristics [Literature: Polym. Degr. Stab. 2004, 85, 855-863].

The dicarboxylic acids i-a and i-b may be employed either as free acids or in the form of ester-forming derivatives. Ester-forming derivatives include in particular the di-C₁- to C₆-alkyl esters, such as dimethyl, diethyl, di-n-propyl, diisopropyl, di-n-butyl, diisobutyl, di-t-butyl, di-n-pentyl, diisopentyl or di-n-hexyl esters. Anhydrides of the dicarboxylic acids may likewise be employed. The dicarboxylic acids or their ester-forming derivatives can be used individually or as a mixture.

The dials 1,3-propanediol and 1,4-butanediol are likewise obtainable from renewable raw materials. It is also possible to use mixtures of the two dials. Due to the higher melting temperatures and better crystallization of the copolymer formed, 1,4-butanediol is preferred as the diol.

At commencement of the polymerization the dial (component i-c) is generally employed relative to the acids (components i-a and i-b) in a ratio of diol to diacids of 1.0:1 to 2.5:1 and preferably 1.3:1 to 2.2:1. Excess amounts of diol are drawn off during the polymerization, so that an approximately equimolar ratio is established at the end of the polymerization. Approximately equimolar is to be understood as meaning a diacid/diol ratio of 0.98 to 1.02.

Employed in one embodiment are 0 to 1% by weight, preferably 0.1 to 0.9% by weight and especially preferably 0.1 to 0.8% by weight based on the total weight of the components i-a to i-b of a branching agent i-d and/or chain extender i-d′ selected from the group consisting of: a polyfunctional isocyanate, isocyanurate, oxazoline, carboxylic anhydride such as maleic anhydride, epoxide (especially an epoxy-containing poly(meth)acrylate), an at least trifunctional alcohol or an at least trifunctional carboxylic acid. Generally no branching agents, but merely chain extenders, are employed.

Suitable bifunctional chain extenders include for example tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate or xylylene diisocyanate, hexamethylene 1,6-diisocyanate, isophorone diisocyanate or methylenebis(4-isocyanatocyclohexane). Particularly preferred are isophorone diisocyanate and especially hexamethylene 1,6-diisocyanate.

Aliphatic polyesters i are to be understood as meaning in particular polyesters such as polybutylene succinate (PBS), polybutylene succinate-co-adipate (PBSA), polybutylene succinate-co-sebacate (PBSSe), polybutylene succinate-co-azelate (PBSAz) or polybutylene succinate-co-brassylate (PBSBr). The aliphatic polyesters PBS and PBSA are marketed, for example, by Showa Highpolymer under the Bionolle® name and by Mitsubishi under the GSPIa® name. More recent developments are described in WO 2010/034711.

The polyesters i generally have a number-average molecular weight (Mn) in the range from 5000 to 100000, in particular in the range from 10000 to 75000 g/mol, preferably in the range from 15000 to 50000 g/mol, a weight-average molecular weight (Mw) of 30000 to 300000, preferably 60000 to 200000 g/mol, and an Mw/Mn ratio of 1 to 6, preferably 2 to 4. The viscosity number is between 30 and 450, preferably from 100 to 400 g/ml (measured in o-dichlorobenzene/phenol (50/50 weight ratio)). The melting point is in the range from 85° C. to 130° C., preferably in the range from 95° C. to 120° C. The MVR range according to DIN EN 1133-1 is between 8 to 40 cm³/10 min (190° C., 2.16 kg).

A stiff component ii that may be employed is polylactic acid (PLA).

It is preferable to employ polylactic acid having the following profile of properties:
a melt volume flow rate (MVR at 190° C. and 2.16 kg according to ISO 1133-1 DE in particular from 30 to 40 cm³/10 minutes)
a melting point below 240° C.;
a glass transition temperature (Tg) greater than 55° C.
a water content of less than 1000 ppm
a residual monomer content (lactide) of less than 0.3%
a molecular weight of greater than 80 000 Dalton.

Preferred polylactic acids are for example NatureWorks® 6201 D, 6202 D, 6251 D, 3051 D and especially 3251 D and also crystalline polylactic acid types from NatureWorks.

The polylactic acid ii is employed in a weight percent fraction based on the components i and iii, of 0% to 35%, preferably of 10% to 28%. It is preferable here when the polylactic acid ii forms the disperse phase and the polyester i forms the continuous phase or is part of a co-continuous phase. Polymer mixtures comprising polyester i in the continuous phase or as part of a co-continuous phase have a higher heat distortion temperature than polymer mixtures in which polylactic acid ii forms the continuous phase.

As mentioned hereinabove the injection molded articles according to the invention exhibit a surprisingly high elastic modulus despite the low polylactic acid content or else despite the complete eschewal of polylactic acid.

Generally employed as component iii are 10% to 35% by weight, in particular 15% to 30% by weight, based on the total weight of the components i to iii of at least one methacryloylsilane- or vinylsilane-modified silicate selected from the group consisting of: kaolin, muscovite, montmorillonite, talc and wollastonite, preferably a wollastonite and especially preferably a kaolin.

The surface modification of the silicate plays a decisive role. Employed for surface modification are methacryloyisilane or vinylsilane. Such silane-modified silicates are marketed for example by Imery, Amberger Kaolinwerke and in particular by Hoffmann Group. In the present injection molded articles outstanding mechanical properties have been achieved by silane-modified wollastonite from Amberger Kaolinwerke, marketed under the brand name Tremin®, and especially preferably silane-modified kaolins from Hoffmann Group, marketed under the name aktifit.

In addition to the surface modification, particle size and aspect ratio (L/D or cross sectional ratio) play a large role.

A small particle size generally results in high notched impact strengths but a relatively low elastic modulus. It is preferable to employ a fine silicate having a proportion of 50% of particles (D₅₀ particle size measured according to ISO 13320-1) below 5 μm, preferably below 2 μm. The proportion of particles below 16 μm, preferably below 10 μm, may be increased to 97% by sieving.

An aspect ratio of 1 to 15 and preferably 2 to 10 and especially preferably of 2 to 6 has proven advantageous. The average aspect ratio may be determined by conductivity measurement as described in EP 528078 B1.

The silicate employed is preferably surface-modified kaolin. Kaolin is a natural product and comprises not only the main constituent kaolinite—a hydrated aluminum silicate—but also other clay minerals and non-decomposed feldspar particles.

A preferred kaolin source is Neuburg siliceous earth, a mixture of corpuscular silica and lamellar kaolinite. The silica here has a round grain shape composed of aggregated primary particles of about 200 nm in size.

Preferably employed is fine kaolin having a sphere-equivalent static-average particle diameter of 0.3 to 1.5 μm; especially preferably from 0.3 to 1.0 μm and a proportion of 50% of particles below 2 μm. The proportion of particles below 10 μm may be increased to 97% by sieving.

The oil absorbtion, a measure of relative surface area, is 23 g/100 g for a coarse kaolin, 45 g/100 g for a fine kaolin and 55 g/100 g for a calcined kaolin.

Calcined kaolin is particularly preferred because of the elevated specific surface area. The water of crystallization of the kaolin fraction is driven out by calcination. In the case of Neuburg siliceous earth the cryptocrystalline silica fraction remains inert during the calcination.

The injection molded articles according to the invention may further comprise 0% to 15% by weight based on the polymer mixture i to iii of other mineral fillers selected from the group consisting of: chalk, graphite, gypsum, conductive carbon black, iron oxide, calcium chloride, sodium carbonate, titanium dioxide and mineral fibers. Fillers from renewable raw materials such as starch, non-thermoplasticized and in particular plasticized starch, cellulose, chitin or chitosan may be present in the injection molded articles according to the invention in amounts of 0% to 10% by weight based on the polymer mixture i to iii.

The inventive compound of components i to iii may also comprise further additives known to those skilled in the art. Examples include the additives customary in the plastics industry such as stabilizers; nucleating agents such as the abovementioned mineral fillers iii or else crystalline polylactic acid; lubricants and release agents such as stearates (especially calcium stearate); plasticizers, for example citric esters (especially acetyl tributyl citrate), glyceryl esters such as triacetylglycerol or ethylene glycol derivatives, surfactants such as polysorbates, palmitates or laurates; waxes, for example erucamide, stearamide or behenamide, beeswax or beeswax esters; antistats, UV absorbers; UV stabilizers; antifogging agents or dyes. The additives are used in concentrations of 0% to 2% by weight, in particular 0.1% to 2% by weight, based on the inventive compound i to iii. Plasticizers may be present in the inventive compound i to iii in amounts of 0.1% to 10% by weight.

In order to obtain the injection molded articles with particularly high notched impact strengths it is possible to add in addition to the inventive surface-modified kaolin either a thermoplastic polyurethane (also referred to hereinbelow as TPU) or a thermoplastic copolyester (also referred to hereinbelow as TPEE).

Thermoplastic polyurethanes are well known. Production is carried out by reaction of (a) isocyanates (hard phase) with (b) isocyanate-reactive compounds/polyol having a number-average molecular weight of 0.5×103 g/mol to 5×103 g/mol (soft phase) and optionally (c) chain extenders having a molecular weight of 0.05×103 g/mol to 0.499×103 g/mol optionally in the presence of (d) catalysts and/or (e) customary auxiliaries and/or additives.

The isocyanate-reactive compound (b) has on average at least 1.8 and at most 3.0 Zerewitinoff-active hydrogen atoms, this number also being referred to as the functionality of the isocyanate-reactive compound (b) and indicating the amount of isocyanate-reactive groups in the molecule theoretically calculated for one molecule from an amount of substance. The functionality is preferably between 1.8 and 2.6, more preferably between 1.9 and 2.2 and in particular 2.

Examples of TPUs particularly preferred for the injection molded articles according to the invention include those obtainable from BASF Polyurethane GmbH under the brand name Elastollan® such as for example: 685A, S80A, SP 806, 1085A, 785A, 595A, 1598 A, 1295 A, N65A or C85A.

Examples of TPEEs particularly preferred for the injection molded articles according to the invention include the products marketed under the brand names Hytrel®, Arnitel®, Riteflex®, Pebax® or Pelprene®.

Generally, injection molded articles having layer thicknesses below 1 mm and preferably below 0.8 mm are biodegradable. Biodegradability results in the polyester (mixtures) decomposing in an appropriate and verifiable timeframe. The degradation may be effected enzymatically, hydrolytically, oxidatively and/or by the action of electromagnetic radiation, for example UV radiation, and may usually be brought about predominantly by the action of microorganisms such as bacteria, yeasts, fungi and algae. Biodegradability may be quantified for example when polyester is mixed with compost and stored for a certain time. For example according to DIN EN 13432 (which refers to ISO 14855) CO₂-free air is passed through matured compost during composting and said compost is subjected to a defined temperature program. Biodegradability is here defined via the ratio of the net CO₂ release from the sample (after subtracting the CO₂ release by the compost without a sample) to the maximum CO₂ release from the sample (calculated from the carbon content of the sample) as a percentage degree of biodegradation. Biodegradable polyester (mixtures) generally show distinct signs of degradation such as fungus growth and tear and hole formation even after just a few days of composting.

Other methods for determining biodegradability are described in ASTM D 5338 and ASTM D 6400-4.

Injection molding is a molding process which is very often used in plastics processing. Injection molding makes it possible to produce immediately usable moldings in large numbers of pieces in extremely economic fashion. In simple terms, the process operates as follows: in an injection molding machine which consists of a heatable barrel in which a screw rotates the respective thermoplastic material (“molding material”) is melted and injected into a mold made of metal. The cavity of the mold determines the shape and the surface structure of the finished molding. Moldings in the weight range from markedly less than 1 g up to double-digit kilogram weights are producible today.

Injection molding makes it possible to produce consumer goods economically and in a short time with high precision. The nature of the surface of the respective component is freely choosable by the manufacturer. From smooth surfaces for optical applications via grains for tactile regions through to patterns or engravings, a multiplicity of surface structures is achievable.

For economic reasons the injection molding process is particularly suitable for the production of large numbers of pieces such as packaging articles.

Articles such as trays for chocolate, trays for board game boxes, clamshells for all sorts of small articles in suspension wall displays for retail sales and yogurt or margarine pots are widely used. Preferred articles are lids for coffee cups or other cups for hot beverages and containers for filling with hot foodstuffs.

A particularly preferred injection molded article is a coffee capsule. A coffee capsule is to be understood as meaning a container having a fill volume of 1 ml to 80 ml, preferably 3 to 50 ml. This container is filled with a pulverulent foodstuff, in particular coffee powder, or a mixture of pulverulent foodstuffs. Foodstuff is to be understood as meaning not only coffee but also tea, milk, cocoa and soup extracts. The shape of the container may be rotationally symmetrical, conical, spherical or else angular, but preferably rotationally symmetrical and largely cylindrical. This container is used for storage of the foodstuff and also for preparation of an aqueous hot beverage produced in a subsequent step by passage of hot water (between 60° C. and 100° C.) through the container. The water passing through dissolves flavour and bitterness chemicals during passage through the container and thus forms the hot beverage.

This container shall be manufactured by injection molding. The flat film used therefor from which the container is produced has a thickness of 100 to 1000 μm, preferably 250 to 800 μm, and in particular 155 to 550 μm. The article may consist of one layer and preferably of a plurality of layers. At least one layer comprises the compound of components i) to iii) described hereinabove. A further layer of the ready-molded container preferably forms a barrier-forming layer. The multilayer construction may be produced by multilayer extrusion during flat film production or else after flat film production applied as a layer by extrusion, printing, spray application or sputtering, in principal by application of a dispersion, a lacquer or a further polymer-based or polymer-comprising system or application of a metallic or oxide-containing layer but preferably by means of a polymer-based or metallized layer. A suitable metallized layer is for example aluminum and suitable polymer-based layers include layers comprising polyglycolic acid (PGA), polyhydroxyalkanoates (PHA) such as for example poly-3-hydroxybutyrate (PHB), poly-3-hydroxybutyrate-co-3-hydroxyvalerate (PHB(V)), poly-3-hydroxybutyrate-co-3-hydroxyhexanoate (PHB(H)) or poly-3-hydroxybutyrate-co-4-hydroxyvalerate; polyvinyl alcohol (PVOH), polyvinylidene chloride (PVDC) or ethylene vinyl alcohol (EVOH). This barrier layer is characterized by an oxygen transmission rate (OTR) measured over the entire film composite after container production according to ASTM D1434 of 0 to 1000 g/m²/d, a water vapor transmission rate according to ASTM F1249 of 0 to 1000 g/m²/d and preferably a simultaneous aroma barrier.

The good oxygen barrier/aroma barrier may also be achieved by means of an outer packaging for one or more coffee capsules. Suitable outer packagings may be plastics films or paper films coated with a barrier film.

Suitable for the injection molding process are in particular compounds of the components i to iii having an MVR (190° C., 2.16 kg), according to ISO 1133-1 of Mar. 1, 2012, of 8 to 40 cm³/10 min, especially preferably 9 to 30 cm³/10 min.

### PERFORMANCE TESTING

The molecular weights Mn and Mw of the semiaromatic polyesters were determined by SEC according to DIN 55672-1. Eluent: hexafluoroisopropanol (HFIP)+0.05% by weight potassium trifluoroacetate; calibration performed with narrow-distribution polymethyl methacrylate standards.

Viscosity numbers were determined according to DIN 53728 Part 3, Jan. 3, 1985, capillary viscometry. An Ubbelohde M-II microviscometer was used. The solvent used was the mixture: phenol/o-dichlorobenzene in a weight ratio of 50/50.

The elastic modulus was determined according to ISO 527-3: 2003 by a tensile test using tensile bars having a thickness of about 420 μm.

The Charpy impact strength was determined according to DIN EN 179-1/1eU:2000+Amd.A (measured at 23° C., 50% rel. H.). The test specimen (80 mm×10 mm×4 mm) mounted close to its ends as a horizontal bar and is subjected to a single impact of a pendulum, wherein the impact line is located centrally between the two test specimen mounts and (the test specimen) is bent at a high, nominally constant speed (2.9 or 3.8 m/s).

The heat distortion temperature HDT-B was determined according to DIN EN ISO 75-2:2004-9. A standard test specimen is subjected to a three-point bending under constant load to generate a flexural stress (HDT/B 0.45 MPa) specified in the relevant part of this international standard. The temperature is increased at a uniform rate (120 K/h) and the temperature at which a predetermined standard flexing, which corresponds to the predetermined flexural strain increase (0.2%), is achieved is measured.

### Starting Materials

Polyester i:
i-1 Polybutylene succinate: GS-Pla® FZ71-PD from Mitsubishi Chemical Corporation (MVR of 22 cm³/10 min (190° C., 2.16 kg))

Component ii:
ii-1 Polylactic acid (PLA) Ingeo® 3251 D from NatureWorks (MVR of 35 cm³/10 min (190° C., 2.16 kg))

Component iii:
iii-1 Aktifit PF 111 from Hoffmann Group, alkylsilane-modified kaolin (comparative)
iii-2 Aktifit AM from Hoffmann Group, aminosilane-modified kaolin (comparative)
iii-3 Aktifit VM from Hoffmann Group, vinylsilane-modified kaolin

### Compounding

The compounds shown in table 1 were manufactured in a Coperion MC 40 extruder. The outlet temperatures were set to 250° C. The extrudate was subsequently granulated underwater. After granulate production the granulate was dried at 60° C.

### Production of the Articles (General Procedure GP)

The compounded material is performed on a Ferromatik Millacron K65 injection molding machine having a 30.00 mm screw. The injection mold was a single- or multi-cavity mold having an open hot runner. Articles were manufactured using ISO 179/1eU: and ISO 527-1/-2: CAMPUS molds. The mold temperature was 30° C. and the molds were filled with an injection pressure of 560 bar and a hold pressure of 800 bar.

TABLE 1

| | | | | | | | | | |
|---|---|---|---|---|---|---|---|---|---|
| Example | V-1 | V-2 | V-3 | V-4 | V-5 | V-6 | 7 | 8 | 9 |

Compounds (amounts in percent by weight)

| | | | | | | | | | |
|---|---|---|---|---|---|---|---|---|---|
| i-1 | 90 | 80 | 70 | 90 | 80 | 70 | 90 | 80 | 70 |
| ii-1 | | | | | | | | | |
| iii-1 | 10 | 20 | 30 | | | | | | |
| iii-2 | | | | 10 | 20 | 30 | | | |
| iii-3 | | | | | | | 10 | 20 | 30 |
| ISO bar thickness (mm) | 3.92 | 3.93 | 3.92 | 3.92 | 3.92 | 3.92 | 3.92 | 3.92 | 3.92 |
| Elastic modulus (MPa) | 797 | 1012 | 1300 | 800 | 1007 | 1313 | 791 | 1032 | 1350 |
| Charpy (kJ/m²) | 6.16 | 5.78 | 3.93 | 7.02 | 7.05 | 6.05 | 7.6 | 7.08 | 6.14 |
| HDT/B (° C.) | 88.0 | 90.4 | 91.3 | 87.5 | 90.1 | 91.7 | 88.6 | 90.1 | 92.6 |

1. An injection molded article comprising
i) 30% to 90% by weight based on the total weight of the components i to iii of a biodegradable polyester comprising:
i-a) 90 to 100 mol % based on the components i-a to i-b of succinic acid;
i-b) 0 to 10 mol % based on the components i-a to i-b of one or more C₆-C₂₀ dicarboxylic acids;
i-c) 99 to 100 mol % based on the components i-a to i-b of 1,3-propanediol or 1,4-butanediol;
i-d) 0% to 1% by weight based on the components i-a to i-c of a chain extender and/or branching agent;
ii) 0% to 35% by weight based on the total weight of the components i to iii of polylactic acid;
iii) 10% to 35% by weight based on the total weight of the components i to iii of at least one methacryloylsilane- or vinylsilane-modified silicate selected from the group consisting of: kaolin, muscovite, montmorillonite, talc and wollastonite.

2. The injection molded article according to claim 1, wherein the surface-modified silicate has an aspect ratio of 1 to 15.

3. The injection molded article according to claim 1, wherein the silicate is a kaolin.

4. The injection molded article according to claim 1, comprising 10% to 25% by weight based on the total weight of the components i to ii of polylactic acid.

5. The injection molded article according to claim 1, comprising 0.5% to 10% by weight based on the total weight of the components i to iii of a thermoplastic polyurethane.

6. The injection molded article according to claim 1 having a notched impact strength according to DIN EN 179-1/1eU:2000 of greater than 6 kJ/m².

7. The injection molded article according to claim 1 having an elastic modulus according to ISO 527-3:2003 of greater than 1300 MPa.
